(19) United States
(12) Patent Application Publication
(10) Pub. No.: US 2016/0260252 A1
(43) Pub. Date: Sep. 8, 2016

(54) SYSTEM AND METHOD FOR VIRTUAL TOUR EXPERIENCE

(71) Applicant: ELECTRONICS AND TELECOMMUNICATIONS RESEARCH INSTITUTE, Daejeon (KR)

(72) Inventors: Yong Wan KIM, Daejeon (KR); Dae Hwan KIM, Daejeon (KR); Yong Sun KIM, Sejong-si (KR); Jin Ho KIM, Daejeon (KR); Dong Sik JO, Daejeon (KR); Ki Hong KIM, Sejong-si (KR)

(21) Appl. No.: 15/057,675

(22) Filed: Mar. 1, 2016

(30) Foreign Application Priority Data
Mar. 6, 2015 (KR) 10-2015-0031770

(51) Int. Cl. G06T 19/00; G06F 3/01; G06F 3/0487; G02B 27/01

(52) U.S. Cl. CPC G06T 19/003; G02B 27/017; G06T 19/006; G06F 3/017; G06F 3/016; G06F 3/0487; G06T 2215/16; H04N 2013/0088

(57) ABSTRACT

A system and method for virtual tour experience are provided. The system includes an image output module configured to output an image of the content for virtual tour experience, a motion recognition module configured to recognize a physical motion of a user, a content running module configured to control motions of a plurality of objects included in the image of the content for virtual tour experience according to the physical motion recognized by the motion recognition module, and a user interface configured to provide to the user a tangible feedback about a geographic environment in the content for virtual tour experience and changes in the motions of the plurality of objects.

### CROSS-REFERENCE TO RELATED APPLICATION

This application claims priority to and the benefit of Korean Patent Application No. 10-2015-0031770, filed on Mar. 6, 2015, the disclosure of which is incorporated herein by reference in its entirety.

### BACKGROUND

1. Field of the Invention

The present invention relates to a system and method for virtual tour experience, and more particularly, to a system and method for virtual tour experience interworking with a motion platform based on a user gesture.

2. Discussion of Related Art

Recently, a variety of virtual reality (VR) content for a head mounted display (HMD) device is being created. Here, the HMD device refers to an HMD which may be put on a user's head. However, most VR content is limited to the sense of sight, and thus it is difficult for a user to feel being present in and interacting with a virtual environment.

Also, with the recent development of technology for a depth map sensor, a wide-viewing-angle HMD, a motion platform, a tangible and wearable interface, etc. capable of precisely finding out a user's motion, demands for an interactive virtual experience system are increasing.

### SUMMARY OF THE INVENTION

The present invention is directed to providing a system and method for virtual tour experience which recognize a gesture fitting a situation intended by a user according to a physical motion of the user and cause the user to experience an interactive content reflecting the gesture in a virtual environment.

According to an aspect of the present invention, there is provided a system for virtual tour experience, the system including: an image output module configured to output an image of content for virtual tour experience; a motion recognition module configured to recognize a physical motion of a user; a content running module configured to control motions of a plurality of objects included in the image of the content for virtual tour experience according to the physical motion recognized by the motion recognition module; and a user interface configured to provide to the user a tangible feedback about a geographic environment in the content for virtual tour experience and changes in the motions of the plurality of objects.

The image output module may include a wide-viewing-angle head mounted display (HMD) covering a viewing angle of the user and a panoramic display device capable of playing a three-dimensional (3D) image and a predetermined distance away from the user. Also, the image output module may further include a wide angle 3D camera capturing an actual environment in a direction of a line of sight of the user, and the actual environment captured by the wide angle 3D camera may be output on a screen through the wide-viewing-angle HMD.

The motion recognition module may recognize the physical motion of the user using a motion sensor sensing a hand motion of the user and a motion of a whole body of the user and a tangible interface in contact with the body of the user to track a motion of an arm of the user.

The content running module may reflect a specific gesture of the user and a change in a line of sight of the user recognized by the motion recognition module the content for virtual tour experience that is output on a screen through the image output module.

The user interface may include: an interface controller configured to control a motion of a motion platform having a form of a vehicle in which the user rides; and a four-dimensional (4D) effect generator configured to provide physical effects produced according to a situation of the content for virtual tour experience to the user.

The user interface may generate the tangible feedback which provides physical effects produced through interactions between the physical motion of the user and the plurality of objects in the content for virtual tour experience by the five senses.

According to another aspect of the present invention, there is provided a method for virtual tour experience using a system for virtual tour experience, the method including: outputting an image of content for virtual tour experience; recognizing a physical motion of a user participating in the virtual tour experience; controlling motions of a plurality of objects included in the image of the content for virtual tour experience according to the physical motion; and providing a tangible feedback to the user according to changes in the motions of the plurality of objects and a geographic environment in the content for virtual tour experience.

The outputting of the image may include outputting the image on a screen in at least one of a form covering a viewing angle of the user and a 3D panoramic form a predetermined distance away from the user. Also, the outputting of the image may include capturing an actual environment in a direction of a line of sight of the user and outputting on a screen.

The recognizing of the physical motion may include recognizing the physical motion of the user including at least one of a hand motion of the user, a motion of a whole body of the user, a motion of an arm of the user.

The controlling of the motions may include reflecting a specific gesture of the user and a change in a line of sight of the user in the content for virtual tour experience output on a screen.

The providing of the tangible feedback may include controlling a motion of a motion platform having a form of a vehicle in which the user rides or providing to the user physical effects produced according to a virtual environment of the content for virtual tour experience. Also, the providing of the tangible feedback may include generating the tangible feedback so that the user feels physical effects produced through interaction between the physical motion of the user and the plurality of objects in the content for virtual tour experience by the five senses.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram of an example image output from a system for virtual tour experience according to an embodiment of the present invention;

FIG. 2 is a block diagram of a system for virtual tour experience according to an embodiment of the present invention;

FIG. 3 is a diagram of an example of a simple constitution of the system for virtual tour experience according to the embodiment of the present invention;

FIG. 4 is a diagram for explaining an operation of an image output module of the system for virtual tour experience according to the embodiment of the present invention;

FIG. 5 is a diagram for explaining an operation of a motion recognition module of the system for virtual tour experience according to the embodiment of the present invention;

FIG. 6 is a diagram for explaining an operation of a user interface of the system for virtual tour experience according to the embodiment of the present invention; and

FIG. 7 is a flowchart of a method for virtual tour experience according to an embodiment of the present invention.

FIG. 8 is a block diagram illustrating a computer system for the present invention.

### DETAILED DESCRIPTION OF EXEMPLARY EMBODIMENTS

Advantages and features of the present invention and a method of achieving the same will be more clearly understood from embodiments described below in detail with reference to the accompanying drawings. However, the present invention is not limited to the following embodiments and may be implemented in various different forms. The embodiments are provided merely for a complete disclosure of the present invention and to fully convey the scope of the invention to those of ordinary skill in the art to which the present invention pertains. The present invention is defined only by the scope of the claims. Meanwhile, the terminology used herein is for the purpose of describing the embodiments and is not intended to be limiting the invention. As used herein, the singular form of a word includes the plural unless the context clearly indicates otherwise. The term “comprise” and/or “comprising,” when used herein does not preclude the presence or addition of one or more components, steps, operations, and/or elements other than stated components, steps, operations, and/or elements.

Hereinafter, exemplary embodiments of the present invention will be described in detail with reference to the accompanying drawings. Throughout the specification, like reference numerals refer to like elements as much as possible even if in different drawings. In describing the present invention, any detailed description of known technology or function will be omitted if it is deemed that such a description will obscure the gist of the invention unintentionally.

While providing the content for virtual tour experience to a person (user) who participates in the virtual tour experience, a system for virtual tour experience according to an embodiment of the present invention recognizes a physical motion of the user and controls an image of the content for the virtual tour experience according to the recognized physical motion of the user. At this point, the system for virtual tour experience according to an embodiment of the present invention may change motions (actions) of a plurality of objects (e.g., animals, characters, etc.) included in the content for virtual tour experience according to the physical motion of the user.

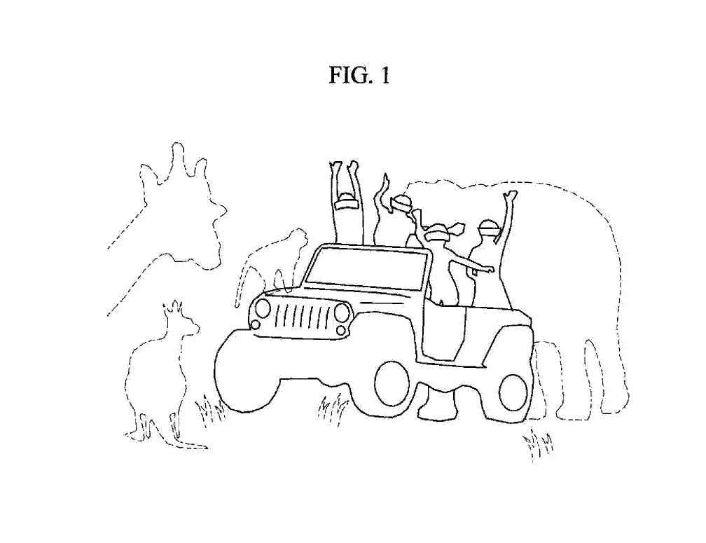

For example, the system for virtual tour experience according to an embodiment of the present invention renders the users who participate in the virtual tour experience and a motion platform having the form of a vehicle in which the users ride onto an image of content for the virtual tour experience including virtual objects (animals), such as a giraffe, a monkey, an elephant, etc., as shown in an example in FIG. 1, thereby enabling the users to experience the virtual tour as if they went on safari in a vehicle.

Also, the system for virtual tour experience according to an exemplary embodiment of the present invention provides a tangible feedback according to a geographic and physical environment in the content for virtual tour experience and changes in the motions of the plurality of objects. At this time, the system for virtual tour experience according to an exemplary embodiment of the present invention produces physical effects through a motion platform having the form of a vehicle that a user is riding and a tangible interface in contact with the user, so that the user may be provided with a tangible feedback by the senses of touch, sight, hearing, smell, etc. of the whole body.

For example, through the system for virtual tour experience according to an embodiment of the present invention, a user in a car may move off road in a safari as in a virtual safari tour experience and enjoy tangible experiences according to interactions with virtual animals at each place. The user may enjoy tangible experiences including, for example, feeding a giraffe, removing water by shaking a hand when an elephant sprays water to the user, shaking hands with a monkey, collecting fireflies hovering around the user at night with a gesture of putting hands together, and so on.

At this point, the system for virtual tour experience according to an exemplary embodiment of the present invention may provide a realistic feeling of driving a vehicle on a pasture to the user by moving and tilting the motion platform in up and down, front and back, and left and right directions. Also, by generating vibrations, wind, sounds, etc. through the tangible interface in contact with the user, it is possible to cause the user to feel as if the user is really in contact with a plurality of objects.

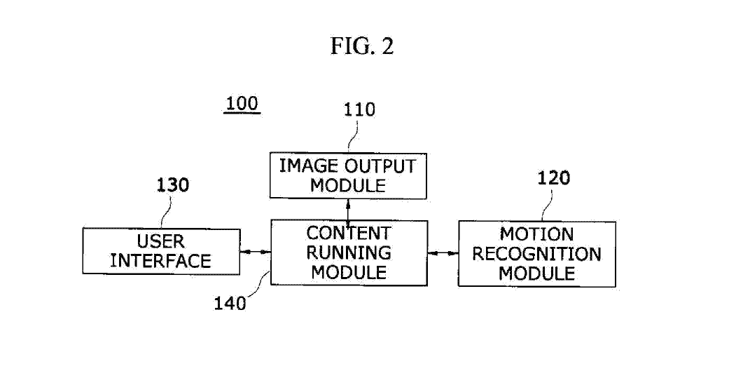

To this end, the system for virtual tour experience according to an embodiment of the present invention includes a constitution shown in FIG. 2.

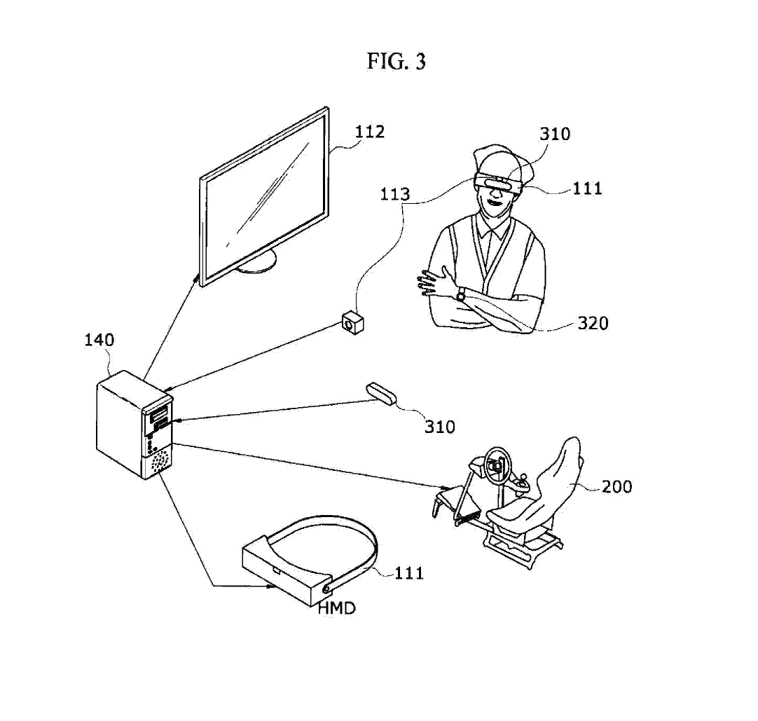

As shown in FIG. 2, a system 100 for virtual tour experience according to an exemplary embodiment of the present invention includes an image output module 110, a motion recognition module 120, a user interface 130, and a content running module 140. Operation of the system 100 for virtual tour experience according to the embodiment of the present invention will be described below with reference to FIGS. 3 to 6. Here, FIG. 3 is a diagram exemplifying a simple constitution of the system for virtual tour experience according to the embodiment of the present invention.

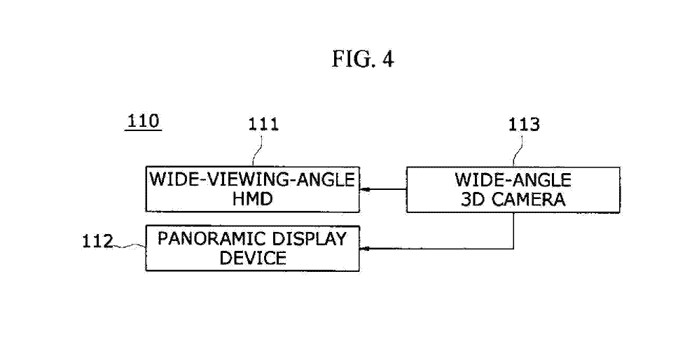

The image output module 110 of the system 100 for virtual tour experience outputs an image of the content for virtual tour experience and provides the image to a user. To this end, the image output module 110 may include a constitution shown in FIG. 4.

As shown as an example in FIG. 3, the image output module 110 includes a wide-viewing-angle head mounted display (HMD) 111 having the form of glasses or goggles which may be put on the user's body (head). The wide-viewing-angle HMD 111 covers most of the user's viewing angle, thereby causing the user to feel as if present in a virtual environment.

Also, the image output module 110 may further include a stationary panoramic display device 112 capable of playing a three-dimensional (3D) image. This is intended to enable the user to be provided with the content for virtual tour experience without wearing the wide-viewing-angle HMD 111. Through the panoramic display device 112, other users who are not wearing the wide-viewing-angle HMD 111 also may be provided with the content for virtual tour experience. As shown in FIG. 3, the panoramic display device 112 may be a liquid crystal display (LCD) fixed at a position a predetermined distance away from a motion platform 200 in which the user rides for virtual tour experience.

In addition, the image output module 110 may output on a screen an actual environment captured by a wide-angle 3D camera 113 which provides a video-through function. To capture an actual environment in a direction of the line of sight of the user, the wide-angle 3D camera 113 may be installed at a predetermined position on the wide-viewing-angle HMD 111 as shown in FIG. 3. This is because the wide-viewing-angle HMD 111 which covers most of the user's viewing angle may make it difficult for the user who wears the wide-viewing-angle HMD 111 to freely take a preparatory action including riding on the motion platform 200 for virtual tour experience and so on.

Here, the wide-angle 3D camera 113 may be fixedly installed in the wide-viewing-angle HMD 111 by a fixing frame tool. Alternatively, the wide-angle 3D camera 113 may also be fixed on the user's forehead by means such as a headband.

Accordingly, before outputting the content for virtual tour experience on a screen, such as before or immediately after the user gets on the motion platform 200, the image output module 110 may provide the user with an actual environment to which the line of sight of the user who wears the wide-viewing-angle HMD 111 is directed.

Meanwhile, an image of the content for 3D virtual tour experience output on the screen by the image output module 110 may be controlled according to a motion of the user recognized by the motion recognition module 120 which will be described below.

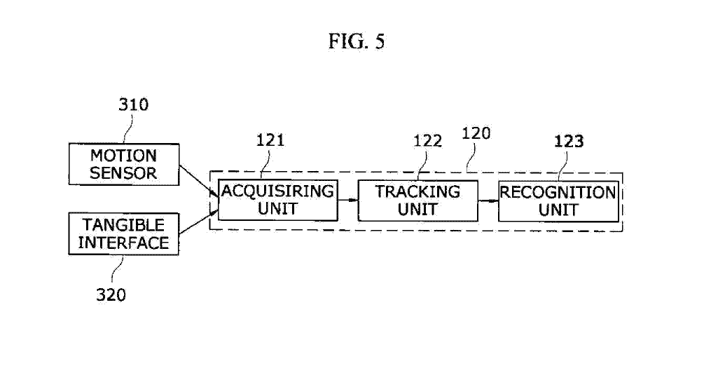

The motion recognition module 120 is intended to recognize a motion of the user's body (hands and major joints of the user's whole body). Specifically, to enable interactions between a plurality of objects included in the content for virtual tour experience and the user, the motion recognition module 120 recognizes the user's gesture. To this end, the motion recognition module 120 may include a constitution shown in FIG. 5.

An acquiring unit 121 acquires sensed data from each of a motion sensor 310 and a tangible interface 320.

Here, the motion sensor 310 may be a depth map sensor for sensing a motion of the user's hand and a motion of the user's whole body. For example, the motion sensor 310 includes a first motion sensor for sensing a motion of the user's hand, and a second motion sensor for sensing a motion of the user's whole body including the arms.

The first motion sensor is intended to sense motions of the hands among parts of the user's body with high precision. For example, the first motion sensor may be a wearable motion sensor attached to the wide-viewing-angle HMD 111 worn by the user as shown in FIG. 3. By the fixing frame tool, the first motion sensor may be fixed on the wide-viewing-angle HMD 111 together with the wide-angle 3D camera 113.

The second motion sensor is intended to sense postures of major joints (e.g., the head, the neck, etc.) of the user's whole body including the arms and is a stationary motion sensor installed at a predetermined position at which the user's whole body may be sensed. For example, the second motion sensor may be positioned close to the panoramic display device 112 so that the whole body of the user who rides the motion platform 200 for virtual tour experience may be sensed. The second motion sensor may not sense parts of the user's body (e.g., the lower body including the legs) covered by the motion platform 200.

The tangible interface 320 is intended to acquire data for incorporating the user's intention (gesture). For example, the tangible interface 320 may be a device, such as a band or a smart watch worn at a predetermined position including the user's wrist, etc., to track a motion of the user's arm. Here, the tangible interface 320 may include a location sensor, an accelerometer, a gyro sensor, and so on.

Also, the acquiring unit 121 may further acquire sensed data from an interior vehicle dashboard 220 installed at a predetermined position in an interior/exterior vehicle mockup 210 and the motion platform 200 including wheels.

A tracking unit 122 tracks a motion of the user's body (a motion of the whole body) using sensed data received from the motion sensor 310, the tangible interface 320, and the motion platform 200. For example, the tracking unit 122 tracks not only a specific motion for a specific gesture of the user recognized by a recognition unit 123 which will be described below but also all postures adopted by the user. The motion of the user's body (posture) tracked in this way may be output through the image output module 110 in real time.

Also, the tracking unit 122 tracks a motion of an actual object capable of moving in an actual environment so that a virtual environment reflects the motion of the actual object as it is. For example, the tracking unit 122 tracks a motion of the motion platform 200 having the form of a vehicle in which the user rides. A motion of a virtual vehicle output through the image output module 110 may reflect the tracked motion of the motion platform 200.

When a plurality of users simultaneously participate in the virtual tour experience, the tracking unit 122 identifies a driver and each of the users (persons participating in the virtual tour experience) other than the driver and performs a continuous multi-person identification and tracking to track a physical motion of each user while providing the content for virtual tour experience.

For example, the tracking unit 122 identifies each of the plurality of users using identifiers (IDs) of a band, a smart watch, and a wearable motion sensor worn by each of the users and tracks a continuous physical motion of each user. Screens showing the content for virtual tour experience provided to the users according to user-specific physical motions tracked in this way may each be output on screens differently depending on the users.

An example of tracking a physical motion of any one of a plurality of users will be described below.

Using sensed data of the motion sensor 310 and the tangible interface 320 acquired through the acquiring unit 121 for a predetermined time, the tracking unit 122 tracks at least one physical motion among body bending, body rotation, and hand motion of a user. To this end, the tracking unit 122 may include a motion recognition algorithm for tracking a physical motion.

For example, the tracking unit 122 may track a physical motion that is a repeated quick up and down movement of the user's hand through the sensed data continuously acquired for the predetermined time. Also, the tracking unit 122 may track a physical motion that is a repeated quick left and right or up and down movements of the user's head through the continuously acquired sensed data

Using the physical motion of the user tracked in this way, the recognition unit 123 may recognize a hand gesture of the user and a change in the line of sight of the user to be reflected in the content for virtual tour experience. At this point, the recognition unit 123 may recognize a gesture of the user corresponding to the tracked physical motion. Here, the gesture corresponding to the tracked physical motion (hand motion) may be matched in advance and stored in a separate database.

For example, when a motion of the user's hand repeatedly moving up and down is tracked by the tracking unit 122, the recognition unit 123 may recognize a “handshake” gesture. In this manner, the recognition unit 123 recognizes gestures (e.g., a handshake, feeding, shaking off water, putting hands together, etc.) of the user appropriate for scene-specific scenarios (situations) constituting the content for virtual tour experience provided to the user.

Also, when a physical motion of the user moving his or her head is tracked by the tracking unit 122, the recognition unit 123 may recognize a movement of the user's focus. This is intended to render a screen output through the wide-viewing-angle HMD 111 according to the natural movement of the user's focus (a change in the line of sight of the user or a rotation of the user's head).

For example, according to a movement of the user's focus recognized by the recognition unit 123, a scene of an image of the content for virtual tour experience output through the image output module 110 may rotate. This may produce an effect as if the line of sight of the user is changing in a virtual 3D space. Such a change in the screen of the content for virtual tour experience according to a physical motion of the user may be made in the same way as in a 3D game programming.

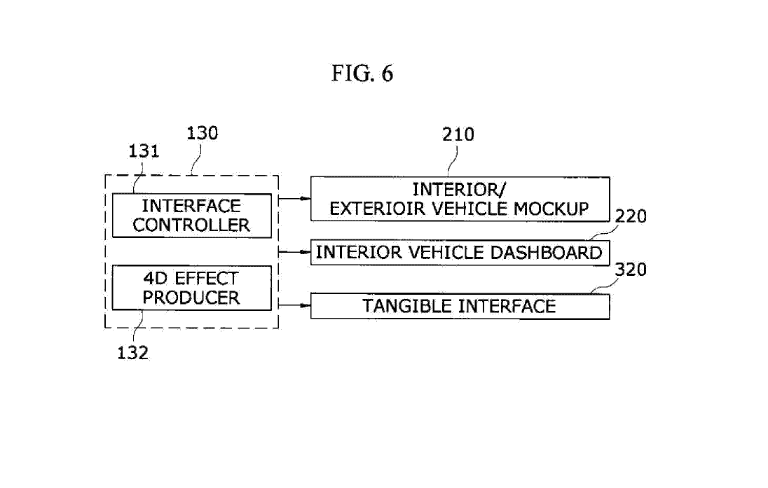

The user interface 130 provides a tangible feedback to the user about a geographic and physical environment in the content for virtual tour experience and changes in motions of a plurality of objects. To this end, the user interface 130 may include a constitution shown in FIG. 6.

An interface controller 131 is intended to control an overall operation of the motion platform 200 for causing the user to feel as if actually riding in a vehicle. As shown in FIG. 3, the motion platform 200 may be implemented in the form of a vehicle. The motion platform 200 may be implemented in the form of a vehicle in which a plurality of users may ride rather than a vehicle in which one person rides as exemplified in FIG. 3.

By controlling hardware (actuator) of the motion platform 200 according to the geographic and physical environment of the content for virtual tour experience, the interface controller 131 may control a motion of the motion platform 200. At this point, by controlling a motion (moving, tilting, etc. in up-down, front-back, and left-right directions) of the interior/exterior vehicle mockup 210 having the form of a vehicle installed on the hardware of the motion platform 200, the interface controller 131 may cause the user riding in the interior/exterior vehicle mockup 210 to feel as if actually riding in a vehicle (e.g., rocking of the vehicle).

At this point, in the interior/exterior vehicle mockup 210, the interior vehicle dashboard 220 may be installed for receiving a manipulation signal due to the user's manipulation of a button, etc. of the vehicle same as in an actual vehicle. The manipulation signal input through the interior vehicle dashboard 220 may be transferred to the content running module 140 which controls the overall operation of the system 100 for virtual tour experience, so that the user's intention may be reflected in the content for virtual tour experience.

For example, when a steering wheel installed in the interior vehicle dashboard 220 is manipulated, a steering wheel manipulation signal may be input, and accordingly, the user's intention to change the direction of the vehicle may be input. At this point, the vehicle wheels installed outside the interior/exterior vehicle mockup 210 may move according to the manipulation direction of the steering wheel.

A 4D effect producer 132 produces various physical effects according to a scenario (situation) of the content for virtual tour experience provided to the user. For example, the 4D effect producer 132 may produce and provide physical effects including wind, smoke, water, vibrations, etc. to the user according to situations such as a cloud of dust, wind, and a puddle (water splashing) which may occur in an off road terrain of the content for virtual tour experience during the virtual tour experience. At this point, the 4D effect producer 132 may produce the physical effects through effect producing equipment installed at a predetermined position in the interior/exterior vehicle mockup 210 at which the user is present.

Also, the 4D effect producer 132 may provide the user with a sense of touch produced through interactions with a plurality of objects in the virtual tour experience according to the user's motion. For example, the 4D effect producer 132 provides a tangible feedback so that the user feels by the five senses a feedback generated according to the motions (e.g., a handshake, petting, etc.) made by the user to various objects including a monkey, a giraffe, a zebra, etc. in the content for virtual tour experience. At this point, the 4D effect producer 132 may generate vibrations, wind, etc. through the tangible interface 320 including a band, a smart watch, gloves, etc. worn by the user as shown in FIG. 3, thereby providing a tangible feedback.

The content running module 140 is a component for performing an overall process of the system 100 for virtual tour experience according to the exemplary embodiment of the present invention and may run all software programs of the system 100 for virtual tour experience. The content running module 140 plays content for virtual tour experience generated by a content creation tool and performs a control so that a resulting image may be output on the screen through the image output module 110. At the same point, when a physical motion of the user is recognized by the motion recognition module 120, the content running module 140 accordingly controls an image of the content for virtual tour experience output on the screen through the image output module 110.

When the virtual tour experience is executed by a manipulation by the user or an administrator, the content running module 140 plays and outputs the content for virtual tour experience on the screen through the image output module 110. Here, the virtual tour experience is a context-based virtual experience and a reaction simulation which provides realistic reactions including motions, tangible feedback, etc. of the various objects included in content for virtual tour experience to the user according to a gesture (physical motion) of the user while outputting scenarios (situations) of scenes constituting the content on the screen.

At this point, the content running module 140 may guide the user through the virtual tour experience based on a virtual avatar which performs functions of a virtual agent so that the user may easily have the experience. For example, the content running module 140 may overlap an image of the virtual avatar on an image (screen) of the content for virtual tour experience played through the image output module 110 and output the images on the screen. Also, the content running module 140 may provide a notification of events (e.g., motions that the user may currently make), a help, etc. through an output of the virtual avatar's speech balloon image or a voice output.

Further, the content running module 140 models an actual environment and matches the image of a virtual environment to the actual environment. This is intended to reduce a feeling of a difference between a virtual vehicle output on the screen and the actual vehicle (the interior/exterior vehicle mockup 210) when the user rides in the motion platform 200 having the form of a vehicle while wearing the wide-viewing-angle HMD 111. The content running module 140 may coincide coordinate data of the modeled actual vehicle with coordinate data of the virtual vehicle output on the screen using an image processing algorithm, thereby matching the image of the virtual vehicle to the actual vehicle.

The content running module 140 may operate by having a selection made according to an input manipulation of the user on whether a scenario flow (scene-specific flows, etc.) of the content for virtual tour experience is proceeded automatically or manually. Such a selection may be switched (manual->automatic, or automatic->manual) by an input manipulation of the user any time while the virtual tour experience proceeds.

Subsequently, the content running module 140 runs a real-time 4D interactive content using information received from each of the components (the user interface 130, the image output module 110, and the motion recognition module 120) of the system 100 for virtual tour experience. Accordingly, the content running module 140 may provide a natural 4D interaction, so that the user is given a feeling that is as if actually being in the virtual environment.

For example, according to a physical motion of the user sensed through the motion recognition module 120, the content running module 140 may change motions of the plurality of objects included in the content for virtual tour experience or rotate a scene of an image output on the screen through the image output module 110 (in left-right, up-down, or other directions). Also, the content running module 140 may provide a tangible feedback by the senses of sight, hearing, touch, etc. through the user interface 130 according to a physical motion of the user and a motion of an object.

Meanwhile, the content running module 140 may create the content for virtual tour experience using the content creation tool. The content for virtual tour experience may be created before the virtual experience is provided to the user. Alternatively, during the virtual tour experience, the content for virtual tour experience may be created by an input manipulation of the user or a provider.

As described above, according to the exemplary embodiment of the present invention, a physical motion of a user is recognized, and an image of the content for virtual tour experience is controlled according to the recognized physical motion of the user. Therefore, it is possible to change motions (actions) of a plurality of objects (e.g., animals, characters, etc.) included in the content for virtual tour experience according to the physical motion of the user.

Also, according to the exemplary embodiment of the present invention, physical effects are produced and provided to the user depending on a geographic and physical environment in the content for virtual tour experience and changes in motions of the plurality of objects. Therefore, the user may be provided with a tangible feedback by the senses of touch, sight, hearing, smell, etc. of the whole body.

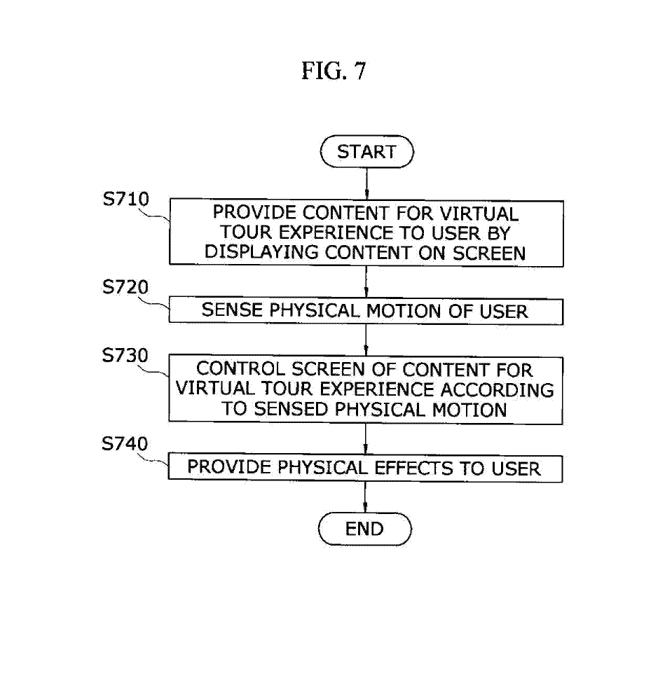

FIG. 7 is a flowchart illustrating a method for virtual tour experience according to an exemplary embodiment of the present invention.

When virtual tour experience is executed by a manipulation by a user or an administrator, an image of content for virtual tour experience is output on a screen and provided to the user (S710).

At this point, the image of the content for virtual tour experience may be output on a screen through the wide-viewing-angle HMD 111 having the form of glasses or goggles which may be put on the user's body (head). The wide-viewing-angle HMD 111 covers most of the user's viewing angle, thereby causing the user to feel as if being in a virtual environment.

Alternatively, the image of the content for virtual tour experience may be output on a screen through the stationary panoramic display device 112 capable of playing a 3D image. This is intended to enable the user to be provided with the content for virtual tour experience without wearing the wide-viewing-angle HMD 111. Through the panoramic display device 112, other users who do not wear the wide-viewing-angle HMD 111 also may be provided with the content for virtual tour experience.

As soon as operation S710 is performed, a physical motion of the user is recognized (S720). This is intended for a plurality of objects included in the content for virtual tour experience and the user to mutually interact.

A motion of the user is recognized using sensed data acquired from the motion sensor 310 for sensing motions of the user's hands and whole body and the tangible interface 320 worn on the user's arm to reflect the user's intention (gesture). At this point, the sensed physical motion (posture) of the user may be output on the screen to overlap the image of the content for virtual tour experience.

For example, using sensed data acquired from the motion sensor 310 and the tangible interface 320 for a predetermined time, at least one physical motion among body bending, body rotation, and hand motion of the user may be tracked.

For example, a physical motion of the user's hand that is a repeated quick up and down movement of. Also, a physical motion of the user's head that is a repeated quick left and right or up and down movements may be tracked.

Using the physical motion of the user tracked in this way, a hand gesture of the user and a change in the line of sight of the user to be reflected in the content for virtual tour experience may be recognized. Here, the gesture corresponding to the tracked physical motion (hand motion) may be set in advance and read from a separate database.

When a motion of the user's hand repeatedly moving up and down is tracked, a “handshake” gesture may be recognized. Like this, gestures (e.g., a handshake, feeding, shaking off water, putting hands together, etc.) of the user appropriate for scene-specific scenarios (situations) constituting the content for virtual tour experience provided to the user may be recognized.

Also, when a physical motion of the user's moving head is tracked, a movement of the user's focus may be recognized. This is intended for rendering a screen output through the wide-viewing-angle HMD 111 according to the natural movement of the user's focus (a change in the line of sight of the user, or rotation of the user's head).

When the physical motion of the user is sensed in operation S720, a screen of the content for virtual tour experience is controlled according to the sensed physical motion (S730).

For example, according to the sensed physical motion of the user, motions of the plurality of objects included in the content for virtual tour experience may be changed, or a scene of an image output on the screen may be rotated (in left-right, up-down, or other directions).

For example, motions of various objects including a monkey, a giraffe, a zebra, etc. in the content for virtual tour experience may be changed according to the physical motion of the user. When a “handshake” gesture is recognized in operation S720, a motion that is as if the user and an object whose image among images of the plurality of objects included in the content for virtual tour experience overlaps or contacts a hand image of the user are shaking hands may be output on the screen.

Accordingly, the user may enjoy tangible elements, such as feeding a giraffe, shaking off water by shaking a hand when an elephant sprays water to the user, shaking hands with a monkey, collecting fireflies hovering around the user at night with a gesture of collecting fireflies in hands, and so on.

Also, according to a movement of the user's focus, a scene of an image of the content for virtual tour experience output on the screen may rotate. This may produce effects as if the line of sight of the user is changed in a virtual 3D space. Such a change in the screen of the content for virtual tour experience according to a physical motion of the user may be made in the same way as in 3D game programming.

Further, various physical effects are produced and provided to the user according to a physical motion of the user and the corresponding motion of an object of the content for virtual tour experience (S740). Specifically, a tangible feedback is provided to the user according to a geographic environment in the content for virtual tour experience and changes in motions of the plurality of objects.

For example, by controlling hardware (actuator) of the motion platform 200 according to the geographic and physical environment of the content for virtual tour experience, it is possible to control a motion of the motion platform 200. At this point, by moving and tilting the interior/exterior vehicle mockup 210 having the form of a vehicle installed on the hardware of the motion platform 200 in front-back, left-right, and up-down directions, it is possible to cause the user riding in the interior/exterior vehicle mockup 210 to feel as if he or she is actually in a vehicle (e.g., rocking of the vehicle).

In another example, various physical effects are produced and provided to the user according to a scenario (situation) of the content for virtual tour experience. For example, physical effects including wind, smoke, water, vibrations, etc. may be produced and provided to the user according to situations such as dust, wind, and a water puddle (water splashing) which may occur in an off road terrain of the content for virtual tour experience during the virtual tour experience. At this point, the physical effects may be produced through effect producing equipment installed at a predetermined position in the interior/exterior vehicle mockup 210 on which the user is.

Also, the user may be provided with a sense of touch produced through interactions with the plurality of objects in the virtual tour experience according to the user's motion. For example, a tangible feedback is provided so that the user feels the sense of touch produced according to a motion (e.g., a handshake, petting, etc.) made by the user to various objects including a monkey, a giraffe, a zebra, etc. in the content for virtual tour experience. At this point, the tangible feedback may be provided through vibrations, wind, etc. generated through the tangible interface 320 including a band, a smart watch, gloves, etc. worn by the user.

As described above, according to exemplary embodiments of the present invention, while content for virtual tour experience is being provided to a person (user) who participates in the virtual tour experience, a physical motion of the user is recognized, and an image of the content for virtual tour experience is controlled according to the recognized physical motion of the user. Therefore, motions (actions) of a plurality of objects (e.g., animals, characters, etc.) included in the content for virtual tour experience may be changed according to the physical motion of the user.

Also, according to exemplary embodiments of the present invention, physical effects are produced and provided to the user depending on a geographic and physical environment in the content for virtual tour experience and changes in the motions of the plurality of objects. Therefore, the user may be provided with a tangible feedback by the senses of touch, sight, hearing, smell, etc. of the whole body.

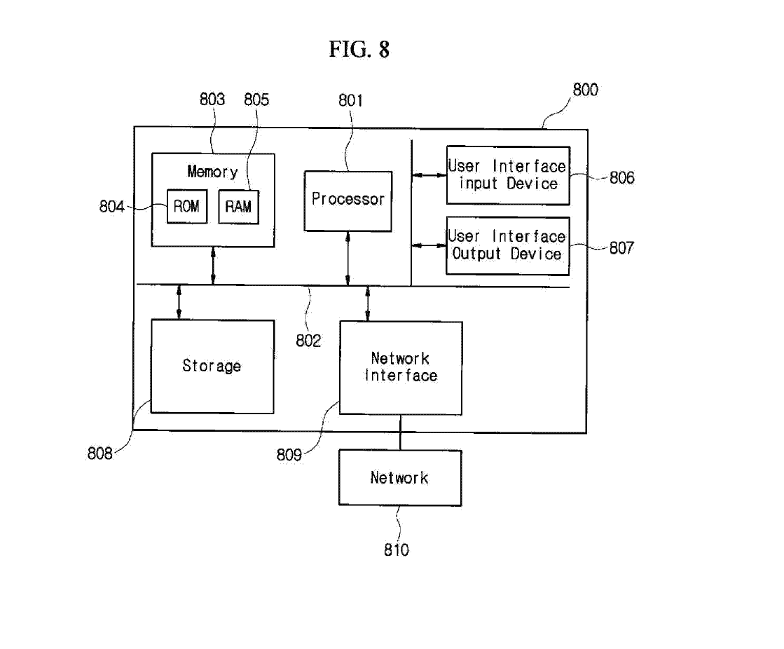

An embodiment of the present invention may be implemented in a computer system, e.g., as a computer readable medium. As shown in in FIG. 8, a computer system 800 may include one or more of a processor 801, a memory 803, a user input device 806, a user output device 807, and a storage 808, each of which communicates through a bus 802. The computer system 800 may also include a network interface 809 that is coupled to a network 810. The processor 801 may be a central processing unit (CPU) or a semiconductor device that executes processing instructions stored in the memory 803 and/or the storage 808. The memory 803 and the storage 808 may include various forms of volatile or non-volatile storage media. For example, the memory may include a read-only memory (ROM) 804 and a random access memory (RAM) 805.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for virtual tour experience, comprising:
an image output module configured to output an image of content for virtual tour experience;
a motion recognition module configured to recognize a physical motion of a user;
a content running module configured to control motions of a plurality of objects included in the image of the content for virtual tour experience according to the physical motion recognized by the motion recognition module; and
a user interface configured to provide to the user a tangible feedback about a geographic environment in the content for virtual tour experience and changes in the motions of the plurality of objects.

2. The system of claim I, wherein the image output module includes at least one of a wide-viewing-angle head mounted display (HMD) covering a viewing angle of the user and a panoramic display device capable of playing a three-dimensional (3D) image and a predetermined distance away from the user.

3. The system of claim 2, wherein the image output module further includes a wide angle 3D camera capturing an actual environment in a direction of a line of sight of the user, and
the actual environment captured by the wide angle 3D camera is output on a screen through the wide-viewing-angle HMD.

4. The system of claim 1, wherein the motion recognition module recognizes the physical motion of the user using sensed data acquired from at least one of a motion sensor sensing a hand motion of the user and a motion of a whole body of the user and a tangible interface in contact with the body of the user to track a motion of an arm of the user.

5. The system of claim 1, wherein the content running module reflects a specific gesture of the user and a change in a line of sight of the user recognized by the motion recognition module in the content for virtual tour experience.

6. The system of claim 1, wherein the user interface includes:
an interface controller configured to control a motion of a motion platform having a form of a vehicle in which the user rides; and
a four-dimensional (4D) effect generator configured to provide physical effects produced according to a situation of the content for virtual tour experience to the user.

7. The system of claim 1, wherein the user interface generates the tangible feedback providing physical effects produced through interactions between the physical motion of the user and the plurality of objects in the content for virtual tour experience by the five senses.

8. A method for virtual tour experience using a system for virtual tour experience, the method comprising:
outputting an image of content for virtual tour experience;
recognizing a physical motion of a user participating in the virtual tour experience;
controlling motions of a plurality of objects included in the image of the content for virtual tour experience according to the physical motion; and
providing a tangible feedback to the user according to changes in the motions of the plurality of objects and a geographic environment in the content for virtual tour experience.

9. The method of claim 8, wherein the outputting of the image includes outputting the image on a screen in at least one of a form covering a viewing angle of the user and a three-dimensional (3D) panoramic form a predetermined distance away from the user.

10. The method of claim 8, wherein the outputting of the image includes capturing an actual environment in a direction of a line of sight of the user and outputting on a screen.

11. The method of claim 8, wherein the recognizing of the physical motion includes recognizing the physical motion of the user including at least one of a hand motion of the user, a motion of a whole body of the user, a motion of an arm of the user.

12. The method of claim 8, wherein the controlling of the motions includes reflecting a specific gesture of the user and a change in a line of sight of the user in the content for virtual tour experience output on a screen.

13. The method of claim 8, wherein the providing of the tangible feedback includes controlling a motion of a motion platform having a form of a vehicle in which the user rides or providing to the user physical effects produced according to a virtual environment of the content for virtual tour experience.

14. The method of claim 8, wherein the providing of the tangible feedback includes generating the tangible feedback so that the user feels physical effects produced through interactions between the physical motion of the user and the plurality of objects in the content for virtual tour experience by the five senses.
